(19) United States
(12) Patent Application Publication
(10) Pub. No.: US 2025/0376221 A1
(43) Pub. Date: Dec. 11, 2025

(54) METHOD FOR PRODUCING A BODY UNIT, AND VEHICLE

(71) Applicant: Volkswagen Aktiengesellschaft, Wolfsburg (DE)

(72) Inventors: Werner KRAUTH, Wolfsburg (DE); Marian Marco DUBOIS, Grafhorst (DE); Holger SOEHNEL, Parsau (DE); Kevin TORNER, Wolfsburg (DE)

(73) Assignee: Volkswagen Aktiengesellschaft, Wolfsburg (DE)

(21) Appl. No.: 19/301,002

(22) Filed: Aug. 15, 2025

Related U.S. Application Data
(63) Continuation of application No. PCT/EP2023/085956, filed on Dec. 14, 2023.

(30) Foreign Application Priority Data
Feb. 15, 2023 (DE) 10 2023 201 286.3

(51) Int. Cl. B62D 25/20

(52) U.S. Cl. CPC B62D 25/2045; B62D 25/2027

(57) ABSTRACT

A method for producing a body unit for a vehicle, the body unit having a firewall unit for frontally delimiting a passenger compartment and having a floor structure for defining a vehicle floor. A bridging unit is mounted for bridging a mounting space for mounting of a functional unit of the vehicle in a force transmission region of the firewall unit for transmitting a force from the firewall unit to the bridging unit such that the bridging unit extends, at least in sections, from the force transmission region toward the passenger compartment. A vehicle is also provided.

This nonprovisional application is a continuation of International Application No. PCT/EP2023/085956, which was filed on Dec. 14, 2023, and which claims priority to German Patent Application No. 10 2023 201 286.3, which was filed in Germany on Feb. 15, 2023, and which are both herein incorporated by reference.

### BACKGROUND OF THE INVENTION

### Field of the Invention

The present invention relates to a method for producing a body unit for a vehicle, and a vehicle.

### Description of the Background Art

When vehicles experience head-on crash load conditions, an application of force can occur to the firewall and/or a firewall crossbeam. In order to bolster the firewall, the force generally is transmitted to the vehicle structure via a support. For example, a tunnel that extends in a central floor region of the passenger compartment is known from the document DE 44 22 498 C1, which corresponds to U.S. Pat. No. 5,562,329, which is incorporated herein by reference. However, usually such supports are mounted later, individually and in full, on the firewall and on the vehicle floor, but this requires time and expense during production of the body unit.

A fundamental improvement in efficiency during manufacture can be achieved in the mounting of vehicle batteries on a body frame, in particular by the means that an interior module, for example with a vehicle battery, seats, a center console, and/or a carpet, is preassembled and subsequently attached to the body frame in a modular manner, for example by insertion from below. In this case, the interior module may be in direct spatial conflict with the support of the firewall. Moreover, it is also desirable to reduce or to avoid the later process of mounting the firewall support.

Furthermore, many vehicle batteries for electric vehicles have additional electronic components such as, e.g., battery management systems or chargers, which likewise are arranged in the vehicle floor. This causes the space required in the floor region to increase, which consequently competes with the space requirements of the support.

### SUMMARY OF THE INVENTION

It is therefore an object of the present invention to at least partially remedy the above disadvantages known from the prior art. In particular, it is an object of the present invention to simplify production of a body unit having a support of a firewall unit and in so doing to reduce an installation space of the support in a region of a vehicle floor.

Features and details that are described in connection with the method according to the invention also apply in connection with the vehicle according to the invention and vice versa in each case, so mutual reference is or can always be made with regard to the disclosure of the individual aspects of the invention.

Accordingly, a method is provided for producing a body unit for a vehicle, the body unit having a firewall unit for frontally delimiting a passenger compartment and having a floor structure for defining a vehicle floor. The method can comprise: mounting a bridging unit that is designed for bridging a mounting space for mounting of a functional unit of the vehicle in a force transmission region of the firewall unit for transmitting a force from the firewall unit to the bridging unit, preferably such that the bridging unit extends, at least in sections or completely, from the force transmission region toward the passenger compartment, which is to say, in particular, opposite a direction of travel of the vehicle; and mounting a supporting element on the floor structure to support the bridging unit with respect to the floor structure such that the bridging unit and the supporting element form a supporting unit for supporting the firewall unit with respect to the floor structure.

The vehicle can be a motor vehicle, in particular in the form of an electric vehicle with a vehicle battery. The body unit can have a body frame that includes the firewall unit and at least a part of the floor structure.

The firewall unit can include a one-piece or multi-piece firewall. “Frontally delimiting the passenger compartment,” which is to say, for example, a vehicle passenger compartment, can be understood as a separation of the passenger compartment from an engine compartment or a trunk compartment of the vehicle. In particular, the firewall unit can extend in a transverse vehicle direction between the engine compartment or the trunk compartment and the passenger compartment. In the event of a collision, the firewall unit can protect the passenger compartment from deformation and/or intruding parts in that the firewall unit absorbs forces and/or deforms itself. In this case, a loading of the firewall unit by the support during the collision can be reduced by transmitting forces into the floor structure of the body unit.

The floor structure can include, for example, one or more cross members and/or a footwell wall of the passenger compartment. In particular, the floor structure can be walkable, at least in sections or completely, by a passenger of the vehicle. Furthermore, the floor structure can have a high stiffness to absorb forces of the support of the firewall unit.

The force transmission region can be part of the firewall unit, for example in the form of a part of the firewall or as an additional component on the firewall. Provision can be made that the bridging unit is attached indirectly or directly to the firewall unit during mounting of the bridging unit. The bridging unit can extend completely into and/or toward the passenger compartment. In particular, the bridging unit can have a longitudinal axis that is parallel or essentially parallel to the direction of travel of the vehicle. Furthermore, the bridging unit can be one-piece or multi-piece in design. For example, the bridging unit is made of a steel and/or of one or more sheet-metal panels.

The “mounting space” can be understood, for example, as an installation space in which the functional unit can be arranged. For this purpose, the bridging unit can be mounted spaced apart from the floor structure on the firewall unit, for example. The functional unit can include, for example, electronics, preferably with a control unit for carrying out a vehicle function. The mounting space can be formed between the vehicle floor and the bridging unit during mounting of the bridging unit. Preferably, the functional unit can be arranged in the mounting space after the mounting of the bridging unit, for example during mounting of the supporting element. The bridging unit advantageously can have a first end, which is mounted with the bridging unit on the force transmission region, and a second end, which is attached to the supporting element or relative to which the supporting element is positioned.

The mounting of the supporting element preferably can take place separately from the mounting of the bridging unit, in particular. Preferably, the mounting of the supporting element takes place after the mounting of the bridging unit. During mounting of the supporting element, the supporting element can be attached to the bridging unit and/or positioned relative to the bridging unit. Moreover, the supporting element can be attached to the floor structure during mounting of the supporting element. Preferably, the supporting element is tunnel-like in design, at least in sections, in order to permit the mounting space to extend in a region between the vehicle floor and the tunnel.

The supporting unit is therefore multi-piece in design, in particular, wherein the bridging unit and the supporting element are composed of at least two separate components. After mounting of the supporting element, the supporting unit can be formed from at least the bridging unit and the supporting element in order to transmit forces from the force application region of the firewall unit through the bridging element to the supporting element and from the supporting element to the floor structure, in particular when the vehicle is in a collision. It has thus been recognized that a multi-piece design of the supporting unit can simplify mounting in the vicinity of the force transmission region. For example, the bridging unit can be preassembled with the firewall unit. Subsequently, with the mounting of the supporting component, for example together with an interior module, a mechanical connection from the firewall unit to the floor structure can be produced or at least prepared in order to achieve a stiffening of the body unit, in particular against frontal collisions. At the same time, the bridging of the mounting space permits better utilization of installation space in the region of the vehicle floor. In order for the bridging unit and the supporting component to form the supporting unit for supporting the firewall unit with respect to the floor structure, the supporting element can, in particular, be arranged in a defined position relative to the bridging unit and/or on the bridging unit.

In addition, provision advantageously can be made in a method according to the invention that the bridging unit is mounted centrally with respect to the firewall unit, in particular on the firewall unit, in a transverse vehicle direction of the vehicle. As a result, the supporting element can be part of a preassembled interior module. In addition, the force transmission region can, in particular, be provided in the center of the firewall unit. The “transverse vehicle direction” can be understood, for example, as a direction that runs substantially perpendicular or perpendicular to a vehicle longitudinal axis and/or substantially parallel or parallel to a wheel axis of the vehicle. Preferably, the bridging unit also can be arranged centrally relative to the firewall unit with respect to a vertical axis of the vehicle. Provision can be made that the firewall unit has a bulge toward the passenger compartment, at which the force transmission region is provided. Owing to the central arrangement, a central force transmission to the floor structure can be made possible and/or a bending moment of the firewall unit can be supportable by the bridging unit. Preferably, the supporting element, in particular the supporting unit, can be integrated at least partially or completely in or into a center console of the vehicle.

Furthermore, the floor structure can have a carrier element, which the supporting element for the support of the firewall unit is arranged on, preferably attached to, during mounting of the supporting element. Owing to the arrangement, in particular direct arrangement, of the supporting element on the carrier element, an advantageous transmission of force to the body frame can take place. The supporting element can have a triangular or essentially triangular cross section with a hypotenuse to support the bridging unit relative to the carrier element. The carrier element can be, for example, a cross member of the body frame, in particular made of steel or aluminum. Advantageously, the supporting element can be passed through an opening in the body frame during mounting of the supporting element in order to be attached, preferably detachably, to the carrier element at the rear. In this case, the supporting element can be, e.g., screwed and/or riveted to the carrier element. It is equally possible, however, that the supporting element is connected in an interlocking manner to the carrier element in order to permit the support of the firewall unit with respect to the floor structure. The arrangement on the carrier element constitutes an advantageous possibility to achieve the mechanical transmission of force to support the firewall unit and at the same time to make possible the mounting space between the supporting unit and the vehicle floor.

It is additionally possible that the supporting element can be preassembled on a floor element of the vehicle floor, which floor element forms a part of a battery housing of a vehicle battery, in particular prior to the mounting on the bridging unit, before the supporting unit is formed during the mounting of the supporting element. Preferably, the functional unit in this case is arranged on or next to the floor element in order to be positioned on the floor structure in the mounting space during mounting of the battery housing. The vehicle battery preferably can be a traction battery that extends over at least a portion of an underbody of the vehicle, for example. The floor element can form a cover of the battery housing and a floor panel of the vehicle floor. During preassembly of the supporting element on the floor element, the supporting element can be screwed to the floor element, for example. Owing to the preassembly of the supporting element on the floor element, the vehicle battery can be prepared for attachment to the body frame in a modular fashion. In particular, it is possible that the supporting element and the floor element are preassembled as part of an interior module, which includes the vehicle battery, seats, a seat cross member, and/or interior trim, such as, e.g., a carpet, for the passenger compartment. The interior module can be connected to the firewall unit and/or to the body frame in the form of a cell-to-car process in which the interior module is moved toward the body frame in such a manner that the supporting element can be positioned relative to the bridging unit to form the supporting unit. As a result, production of the body unit can be simplified. The multi-piece design of the supporting unit offers the possibility here of preparing the supporting unit in separate subprocesses.

The floor structure can have a top that is oriented toward the passenger compartment and a bottom that is opposite the top, wherein the battery housing with the preassembled supporting element is arranged on the bottom of the floor structure, in particular during mounting of the supporting element. In this case, the battery housing and/or the interior module can be moved from the bottom toward the floor structure and/or the floor structure moved toward the battery housing, in particular so as to perform a so-called marriage of the vehicle battery to a body frame of the body unit. Preferably, the supporting element can be inserted into an opening in the floor structure in this process in order to be arranged between the carrier element and the bridging unit. Especially when the supporting element and the battery housing are part of the preassembled interior module, the assembly time for mounting the supporting element and/or the battery housing can be shortened as a result. In addition, it is possible by this means to avoid undercuts in the joining process, also called marriage, in particular between a center console of the vehicle and the firewall unit. Preferably, the battery housing can be attached to the bottom of the floor structure in order to secure the interior module to the body frame. The top of the floor structure and/or the floor element can form a floor region of the passenger compartment in this case. During insertion, the functional unit can be positioned in the mounting space, in particular automatically, when the functional unit is part of the interior module and/or is preassembled on the battery housing.

The bridging unit can have two bridging elements that extend from the force transmission region toward the supporting element, in particular substantially parallel or parallel to one another and/or through a part of the passenger compartment, preferably such that the mounting space extends between the bridging elements. Preferably, the bridging elements can run parallel or essentially parallel to the vehicle longitudinal axis and/or define a longitudinal extent of the bridging unit toward the passenger compartment. As a result, the mounting space can be enlarged in an upper region, at least in sections. The bridging elements can be rod-like and/or bar-like in design. Furthermore, the two bridging elements can have a rectangular cross section in order to permit an advantageous strength against bending and/or buckling. Each of the bridging elements can have a front end for arrangement in the force transmission region and a rear end for arrangement on the supporting element. The bridging elements can thus have a bridge-like design. An advantageous utilization of installation space with high stiffness at the same time can thus be made possible by the bridging elements.

The bridging unit can be arranged spaced apart from the floor element, at least in sections, wherein openings through which the mounting space extends are formed between the bridging unit, the floor element, and the supporting element. Due to the openings, the mounting space for the functional unit can extend beneath the bridging elements. In particular, the mounting space for the functional unit can be widened through the openings, so that the functional unit can be designed independently of a distance of the bridging elements from one another, at least beneath the bridging elements. In particular, the functional unit can be positioned below the bridging elements when the battery housing is being arranged on the bottom of the floor structure. Consequently, mounting of the interior module can be simplified and an allocation of installation space improved.

The bridging unit can have lateral supports for section-wise bridging of the openings, in particular wherein the lateral supports are already connected to, or become connected to, the bridging elements during mounting of the bridging unit and preferably are connected to the floor structure during mounting of the bridging unit and/or are connected to the floor structure and/or to the floor element during mounting of the supporting element. The lateral supports can be composed of tabs. In particular, a lateral support can be attached to each of the bridging elements. For example, the lateral supports can be welded to the bridging elements and/or be integrally constructed. Preferably, the lateral supports and the bridging elements can be made of the same material. Each of the lateral supports can have an attachment region for attaching the respective lateral support to the floor structure and/or to the floor element. For example, the lateral supports can be screwed to the floor element when the battery housing is being arranged on the bottom of the floor structure. A stiffening of the bridging unit in a manner suitable for mounting that restricts the mounting region only slightly or not at all can be realized by means of the lateral supports.

In addition, provision advantageously can be made in a method according to the invention that the bridging unit, in particular at least one of the bridging elements or both bridging elements, can be connected to the supporting element by at least one mounting element, which is attached to the bridging unit and to the supporting element, during mounting of the supporting element, or the supporting element is arranged spaced apart from the bridging unit, in particular from the bridging elements, in order to allow the support of the firewall unit with respect to the floor structure in the event of a movement of the bridging unit, in particular the bridging elements, toward the supporting element. Insertion clearance can be created by spacing apart the supporting element and the bridging unit, by which means mounting of the supporting element is simplified. For example, in this way a movement of the vehicle battery toward the passenger compartment can be made possible and/or simplified in order to mount the vehicle battery on the bottom of the floor structure. The spacing apart of the supporting element and the bridging unit can be, for example, less than 20 mm, preferably 10 mm. The movement of the bridging unit can occur as a result of a deformation of the firewall unit and/or a displacement of the firewall unit owing to a deformation, for example. In particular, an interlocking contact between the bridging unit, preferably the bridging elements, and the supporting element can be established during the movement of the bridging unit in order to support the firewall unit. The spacing can be bridged by the mounting element in order to permit a permanent mechanical connection of the bridging unit and the supporting element. The mounting element advantageously can be connected detachably, e.g., by a screw connection, to the bridging unit and/or the supporting element in order to simplify a maintenance and/or a replacement of individual components. Preferably, two mounting elements are provided that each connect one of the bridging elements to the supporting element. Consequently, the support of the firewall unit in the case of a collision can be ensured and high suitability for mounting can be achieved at the same time.

According to a further aspect, a vehicle is provided. The vehicle has a body unit that is produced by a method according to the invention.

Consequently, a vehicle according to the invention provides the same advantages as have already been described in detail with respect to a method according to the invention. In particular, an underbody of the vehicle can be formed at least partially by a vehicle battery that forms a floor of a passenger compartment of the vehicle and/or a carrier for seats of the vehicle. A floor structure of the body unit and the vehicle battery can be formed of preassembled modules.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a method according to the invention in a schematic representation of method steps,

FIG. 2 shows a supporting unit that is formed in the method,

FIG. 3 shows a bridging element and a supporting element when the supporting unit is being formed,

FIG. 4 shows a vehicle according to the invention with a body unit that is produced via the method, and

FIG. 5 shows a supporting unit in another example.

### DETAILED DESCRIPTION

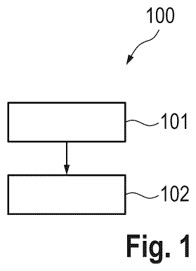

FIG. 1 shows a method 100 according to the invention for producing a body unit 10 for a vehicle 1. The vehicle 1 is depicted with the body unit 10 in FIG. 4. Here, the body unit 10 has a firewall unit 11 for frontally delimiting a passenger compartment 2 and a floor structure 12 for defining a vehicle floor 3. The floor structure 12 has a top 12.1 that is oriented toward the passenger compartment 2, and a bottom 12.2 that is opposite the top 12.1. Arranged on the bottom 12.2 of the floor structure 12 in this case is a vehicle battery 15 with a battery housing 16. For supporting the firewall unit 11 with respect to the floor structure 12, a supporting unit 20 is also provided that extends at least partially inside the passenger compartment 2, in particular. Furthermore, a mounting space 30 is formed underneath the supporting unit 20, in particular, in which is arranged a functional unit 31 of the vehicle 1, here a control unit of the vehicle battery 15 and/or of the vehicle 1.

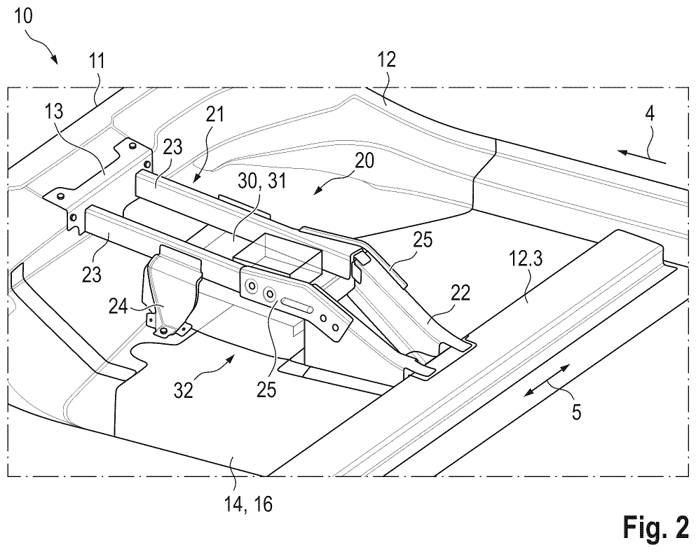

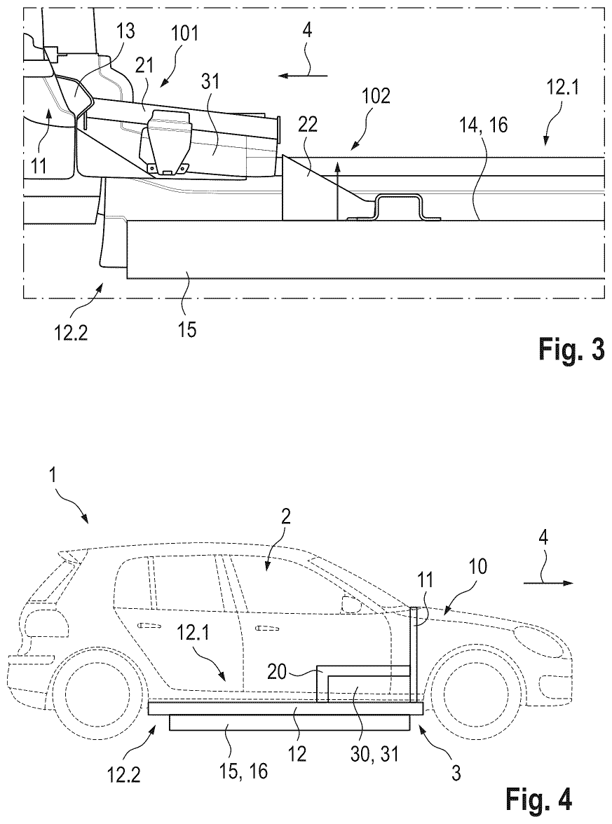

As depicted in FIG. 2 and FIG. 3, in the method 100 for producing the body unit 10, first a mounting 101 of the bridging unit 21 takes place in a force transmission region 13 of the firewall unit 11, which region is provided centrally on the firewall unit 11 for transmitting a force from the firewall unit 11 to the bridging unit 21. Consequently, the bridging unit 21 is mounted centrally with respect to the firewall unit 11 in a transverse vehicle direction 5 of the vehicle 1, which is to say, in particular, perpendicular to a direction of travel 4. The mounting 101 of the bridging unit 21 in this case takes place in such a manner that the bridging unit 21 extends, at least in sections, from the force transmission region 13 toward the passenger compartment 2. For this purpose, two bridging elements 23 of the bridging unit 21 are arranged parallel to one another, each with a first end on the force transmission region 13, such that the mounting space 30 extends between the bridging elements 23. The bridging elements 23 are rod-like and/or bar-like in design and extend toward a vehicle rear end, which is to say, in particular, toward a supporting element 22, preferably up to the supporting element 22, when the supporting element 22 is in the installed state. In addition, the bridging unit 21 has lateral supports 24 for section-wise bridging of openings 32 through which the mounting space 30 extends. The lateral supports 24 are already connected to the bridging elements 23, in particular integrally, at mounting 101 of the bridging unit 21. Alternatively, the lateral supports 24 can be connected, for example by welding, to the bridging elements 23 during mounting 101 of the bridging unit 21.

As is furthermore shown in FIG. 3, a mounting 102 of the supporting element 22 on the floor structure 12 to support the bridging unit 21 with respect to the floor structure 12 occurs during the method 100 such that the bridging unit 21 and the supporting element 22 form a supporting unit 20 for supporting the firewall unit 11 with respect to the floor structure 12. For this purpose, the supporting element 22 is first preassembled on a floor element 14 of vehicle floor 3, which floor element forms a part of the battery housing 16 of the vehicle battery 15. Preferably, the functional unit 31 is integrated in the battery housing 16 and/or is preassembled on the floor element 14 and/or beneath the bridging unit 21. Subsequently, the supporting unit 20 is formed during mounting 102 of the supporting element 22. In this case, the battery housing 16 with the preassembled supporting element 22 is arranged on the bottom 12.2 of the floor structure 12.

As shown in FIG. 2, the lateral supports 24 can be connected to the floor structure 12 and/or to the floor element 14 during mounting 101 of the bridging unit 21 and/or during mounting 102 of the supporting element 22. During positioning of the battery housing 16, the bridging unit 21 is arranged spaced apart from the floor element 14, at least in sections, such that the openings 32 are formed between the bridging unit 21, the floor element 14, and the supporting element 22. Furthermore, the functional unit 31 can be positioned automatically in the mounting space 30 during the positioning of the battery housing 16.

For the support of the firewall unit 11 with respect to the floor structure 12, the supporting element 22 is furthermore arranged on a carrier element 12.3 of the floor structure 12, which carrier element can be composed of a cross member, for example. For an at least partial enclosing of the carrier element 12.3, the supporting element 22, in particular with the battery housing 16, can be moved at least partially toward the vehicle rear end and/or be deformed at least in some areas, during the arrangement of the battery housing 16 on the bottom 12.2 of the floor structure 12.

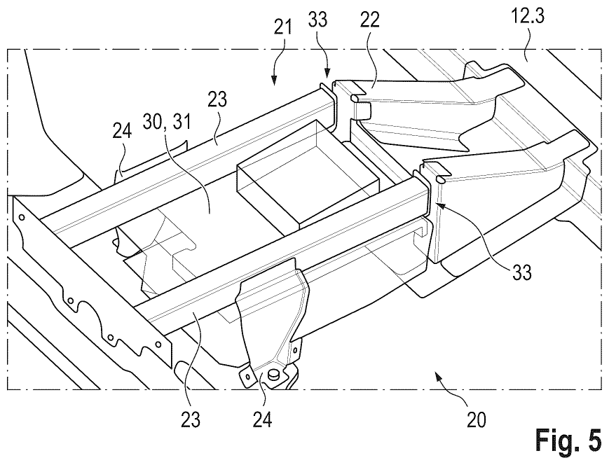

As shown in FIG. 2, the bridging unit 21 furthermore can be connected to the supporting element 22 by two mounting elements 25 during mounting 102 of the supporting element 22, each of which mounting elements is attached, preferably detachably, to one of the bridging elements 23 and to the supporting element 22. Alternatively, provision can be made according to FIG. 5 that the supporting element 22 is arranged spaced apart from the bridging elements 23 by a distance 33 in order to allow the support of the firewall unit 11 with respect to the floor structure 12 in the event of a movement of the bridging elements 23 toward the supporting element 22. For example, the movement can occur as a result of a deformation of the firewall unit 11.

The above explanation of the examples describes the present invention solely within the framework of examples. Individual features of the examples can of course be combined freely with one another, insofar as is technically appropriate, without departing from the scope of the present invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to produce a body for a vehicle, the body having a firewall for frontally delimiting a passenger compartment and having a floor structure for defining a vehicle floor, the method comprising:
mounting a bridge that bridges a mounting space to mount a functional unit of the vehicle in a force transmission region of the firewall to transmit a force from the firewall to the bridge such that the bridge extends, at least in sections, from the force transmission region toward the passenger compartment; and
mounting a support on the floor structure to support the bridge with respect to the floor structure such that the bridge and the support form a support structure to support the firewall with respect to the floor structure.

2. The method according to claim 1, wherein the bridge is mounted centrally with respect to the firewall in a transverse vehicle direction of the vehicle.

3. The method according to claim 1, wherein the floor structure has a carrier on which the support structure for support of the firewall is arranged during mounting of the support.

4. The method according to claim 1, wherein the support is preassembled on a floor element of the vehicle floor, which floor element forms a part of a battery housing of a vehicle battery, before the support structure is formed during the mounting of the support.

5. The method according to claim 4, wherein the floor structure has a top that is oriented toward the passenger compartment and a bottom that is opposite the top, and wherein the battery housing with the preassembled support is arranged on the bottom of the floor structure.

6. The method according to claim 1, wherein the bridge has two bridging elements that extend parallel to one another from the force transmission region toward the support such that the mounting space extends between the bridging elements.

7. The method according to claim 1, wherein the bridge is arranged spaced apart from the floor element, at least in sections, and wherein openings through which the mounting space extends are formed between the bridge, the floor element, and the support.

8. The method according to claim 1, wherein the bridge has lateral supports for section-wise bridging of the openings, wherein the lateral supports are already connected to, or become connected to, the bridging elements during mounting of the bridge and are connected to the floor structure during mounting of the bridge and/or are connected to the floor structure and/or to the floor element during mounting of the support.

9. The method according to claim 1, wherein the bridge is connected to the support by at least one mount, which is attached to the bridge and to the support, during mounting of the support, or wherein the support is arranged spaced apart from the bridge in order to allow the support of the firewall with respect to the floor structure in an event of a movement of the bridge toward the support.

10. A vehicle comprising a body that is produced by the method according to claim 1.
